(19) United States
(12) Patent Application Publication
(10) Pub. No.: US 2010/0238488 A1
(43) Pub. Date: Sep. 23, 2010

(54) Method and Apparatus for Printing

(76) Inventors: Nader Alaghband, London (GB); Adam Cohen, New York, NY (US)

Correspondence Address: BRINKS HOFER GILSON & LIONE, P.O. BOX 10395, CHICAGO, IL, 60610, US

(21) Appl. No.: 12/664,839

(22) PCT Filed: Jun. 19, 2007
(86) PCT No.: PCT/GB08/02102

§ 371 Date: Jun. 7, 2010

(30) Foreign Application Priority Data
Jun. 19, 2007 (GB) 0711867.2

(51) Int. Cl. G06F 15/00

(52) U.S. Cl. 358/1.15

(57) ABSTRACT

A print server receiving a print job, adding the print job to a print queue, receive at multiple times from a print system remote from the print queue, a communication checking for the presence of a print job on the print queue, and transmitting to the print system the print job in response to the communication.

A method of printing by uploading a file to a file store, selecting a remote printer from a list of available printers, and creating a print job for printing the uploaded file with the selected printer.

### FIELD OF THE INVENTION

The present invention relates to a method and apparatus for printing and in particular a print server for remote printing.

### BACKGROUND OF THE INVENTION

Organisations often have surplus printing resources in order to ensure that peak demand can be met. For instance, in a networked office environment several printers may be connected to the network via an Ethernet. Each printer on a network may have its own local print queue and users wishing to print may choose a particular printer on the network and add print jobs to the print queue as required.

A user within the office usually needs to set up one or more of the available networked printers from their own computer or work station. This restricts access to the printers to users having access to the office network. It is often difficult for visitors to such an office to use one of the printers without first gaining access to the local network.

Organisations may be reluctant to open up their printer resources to third parties due to security reasons because this may require exposing their network. Subsequently, printer resources are limited to permanent users and so use of the printer resources may be further limited.

Furthermore, it is often desirable to print documents or other materials from mobile devices, which are often remote from a printer network. Internet based printing systems have been proposed but have a number of drawbacks.

US 2003/0193687 describes a remote printing network in which a first mechanism receives information with respect to the presence of one or more printers connected to the network and selecting an available printer in response to this information. A second mechanism pulls a document from the first mechanism in preparation for printing via the available printer. However, because the document still needs to be transferred to the selected printer by the user's computer such a system lacks security and exposes the network to additional risk. Furthermore, such a system may compromise the privacy or security of the printed documents.

Therefore, there is required a print system and method of printing that overcomes these problems.

### SUMMARY OF THE INVENTION

In accordance with a first aspect of the present invention there is provided a print server and associated print queue that receives from a remote print system a communication at multiple times checking for the presence of a print job on the print queue and in response to this communication transmits the print job to the print system. Therefore, the printer network or resource needs only to allow access to the print server, whereas the print server may which accept and add print jobs to its own queue thereby reducing the risk to the printer network. In other words, the print server acts as an intermediary between a generator of print jobs and the printing system printing those print jobs. The communication may be received at multiple times or at intervals, such as regular or irregular intervals or intermittently.

Optionally, the print system may be a standalone printer, a computer and printer combination and/or a network of printers and print queues local to the network.

Preferably, the print system and the print server are in communication via a network, for instance an internal network such as an intranet or the Internet.

Advantageously, the print server may further comprise a file store arranged to transmit files associated with the print job to the print system. The file store may be incorporated into the print server or separate from it. Alternatively, the file store may be a database server.

Optionally, the communication may be transmitted as a message across a message broker. A message broker allows for a more robust, secure and/or reliable messaging and communication system.

Preferably, the communication received by the print server contains a message to pull the print job from the print queue. Alternatively, the receipt of a communication or message from the print system may be interpreted as a signal to transmit the print job to the print system. Once a print job has been retrieved from the print queue a file associated with the print job may then be retrieved allowing a short message or communication to initiate the print job. The communication may also indicate the availability of the print system. This indication of availability may cause the print job to be transmitted.

Optionally, the print system may be arranged to receive an instruction to hold the print job prior to printing. Therefore, the print job may remain held until the print requester authorises the printing locally or the print job may simply be executed as soon as the printer is ready. The request to print the held job may be transmitted by the print server or from a computer local to the printer. This provides options for securing documents or files that require additional security and should not be available without the print requester's permission.

Optionally, the print server may further comprise a file store arranged to store files associated with print jobs. Therefore, the files may be stored separately to the print jobs.

Optionally, the file store may receive files using any convenient transfer mechanism including email, FTP, HTTP, SMS, MMS, WAP, GPRS and encrypted file transfers such as symmetric and asymmetric encryption. Encryption may be used to transfer files to and from the file store.

Advantageously, a user may initiate a print job using any suitable computer including a personal computer, a laptop computer, a mobile computer, a cell phone and a PDA. The user's computer may send files to the file store across the Internet or an Intranet, a WiFi network and/or a mobile network. The user may select printing options including selection of paper type, ink, toner, colour, size, duplex and collating requirements.

Preferably, the computer attached to the print system receives the status of one or more printers within the print system and then communicate the status of any of these associated printers with the print server. The print server may then determine whether or not a particular printer or computer attached to the print system is off-line. If the print server does not receive a valid status from the print system it may be considered off-line. This may be determined by the expiring of a time limit from the last received message or communication. For instance if a printer is out of paper, becomes jammed, is turned off, or requires some form of maintenance the computer attached to the print system may send an off-line status message to the print server.

Advantageously, the print server may communicate the printer status to a user or customer. This may be in the form of providing a list of one or more available printers to the user from which the user may choose an available printer. This communication may be achieved by a messaging broker. For instance an email or SMS notification that a printer has gone off-line.

Optionally, one or more print systems may be present in the system. Therefore, the print server may monitor these one or more print systems.

Preferably, the user may be presented with a list of available printers and may chose one of these printers based on one or more properties of the printers. These properties may include location, cost, quality and/or any other property.

According to a second aspect of the present invention there is provided a method of printing comprising the steps of adding a print job to a print queue, receiving a communication from a print system remote from the print queue checking for the presence of a print job, transmitting the detected print job from the print queue to a print system remote from the print queue, and printing the transmitted print job using the print system. The print system may be a single printer, a networked printer or printers and/or a computer attached to a printer or network of printers. Other arrangements of computers and printers may make up the print system.

According to a third aspect of the present invention there is provided a method of printing comprising the steps of uploading a file to a file store, selecting a remote printer from a list of available printers, and creating a print job for printing the uploaded file with the selected printer.

Preferably, the file store may be indexed and searchable. Therefore, the uploaded files may be associated with a username belonging to a user who uploaded the file and searchable according to the username, file name, content, date and other criteria. The user may have an account and the account may be associated with all uploaded documents or files and past and present print jobs.

The present invention also extends to a computer program comprising instructions that, when executed on a computer cause the computer to perform the methods of printing, as described above.

The present invention also extends to a computer programmed to perform the methods for printing, as described above.

According to a fourth aspect of the present invention there is provided a computer programmed to transmit a communication indicating the availability of a print system at multiple times to a print server having a print queue, wherein the print server is remote from the computer, receive from the print queue a print job in response to the communication, and print the received print job using the print system.

Preferably, the computer may receive a communication from the print server indicating that a print job is available. The print server may send the communication in response to a communication sent by the computer indicating its availability or requesting print jobs. On receipt of this communication the computer may request delivery of the available print job. As the computer may request the print job or pull the print job this can make it easier to transfer information between the print server and the print system. For instance, a print system residing behind a firewall could restrict files and communications (such as print jobs and the printed file) from being pushed through the firewall from the print server side. Pulling the print job and/or file may avoid this restriction.

Preferably, the computer may be associated with a printing device such as a printer.

Optionally, the computer may be contained within, attached to or be a component of a printing device.

Optionally, the computer may be attached to a network with one or more attached printers.

Advantageously, the computer may generate the communications received by the print server according to the first aspect of the present invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a print server and system according to an embodiment of the present invention, given by way of example only;

FIG. 2 shows a more detailed schematic diagram of the print server and system of FIG. 1;

FIG. 3 shows a flow diagram representing a method for configuring and registering with the print server and system of FIGS. 1 and 2;

FIG. 4 shows a flow diagram of a method for printing according to an embodiment of the present invention using the print server and system of FIGS. 1 and 2, given by way of example only.

FIG. 5 shows a flow diagram of an alternative method of printing using the print server and system of FIGS. 1 and 2;

FIG. 6 shows a flow diagram of a method for configuring and registering with the print server and system according to a further aspect of the present invention, given by way of example only;

FIG. 7 shows a flow diagram of a method for uploading documents to be printed using the print server and system of FIGS. 1 and 2;

FIG. 8 shows a flow diagram of an alternative embodiment of adding documents to be printed, given by way of example only;

FIG. 9 shows a flow diagram of an alternative embodiment according to the present invention, of adding documents to be printed using the print server and system of FIGS. 1 and 2, given by way of example only;

FIG. 10 shows a flow diagram of a method according to a further embodiment of the present invention for queuing print jobs, given by way of example only; and

FIG. 11 shows a flow diagram of a method according to a further aspect of the present invention for registering and configuring the print server and system of FIGS. 1 and 2, given by way of example only.

It should be noted that the figures are illustrated for simplicity and are not necessarily drawn to scale or contain all of the method steps.

### DETAILED DESCRIPTION OF THE PREFERRED EMBODIMENTS

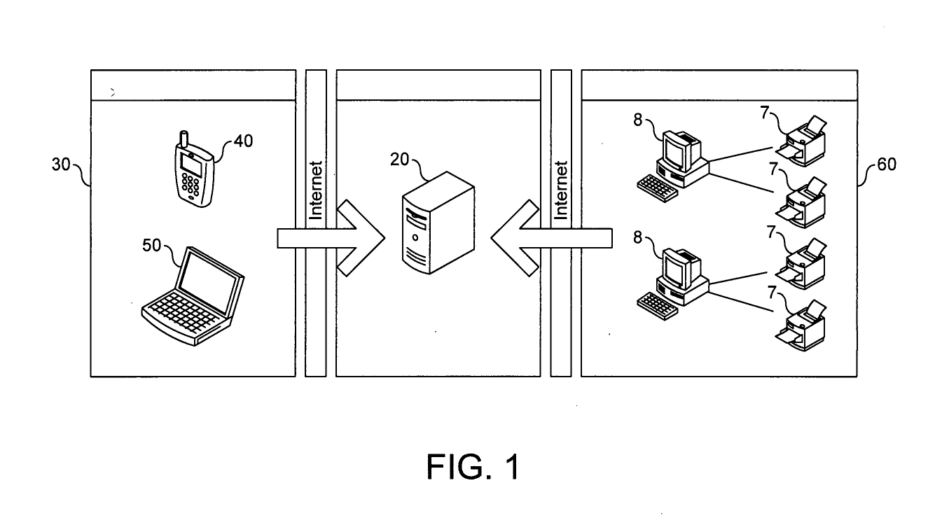

FIG. 1 shows a schematic diagram of a print system according to one aspect of the present invention. A central server 20 contains a print server has at least one print queue associated with it. The central server may be connected to the Internet in order to communicate with external computers 30 that include mobile phones 40 and laptop computers 50. These external computers 30 may be used by customers who wish to print one or more documents but that are not necessarily connected themselves directly to a printing resource.

The central server 20 may also be connected to one or more sets of print systems 60. Each print system may comprise a printing computer 8, such as a desktop PC which itself may be connected to one or more printing devices 7.

The users of the external computers 30 may wish to print a document. To do this they may upload the document to be printed via the Internet or other network to the central server 20 and then in the same or a separate step, create a print job to print this uploaded document. The central server 20 adds this print job to a print queue where it is queued until one of the printing computers 8 sends a message to the central server 20 effectively requesting the print job. Alternatively, the message may indicate the availability of the originating print system 60 and this message may then be interpreted as a request for a print job. On receipt of this request the central server 20 transmits the print job and document file to the printing computer 8, which then directs the print job to one of its connected print devices 7, which may be a printer. In this way the user of one of the external computers 30, may be able to print out a document and the print systems 60 may be able to receive a document to be printed without requiring the direct connection of one of the external computers 30 onto a local network. Also, the printing computers 8 may be able to control how their printing resources 7 are used by only requesting print jobs when the receipt of print jobs is required. This avoids problems such as populating local print queues when the printer is off-line or tying up a printing resource when local demand is high.

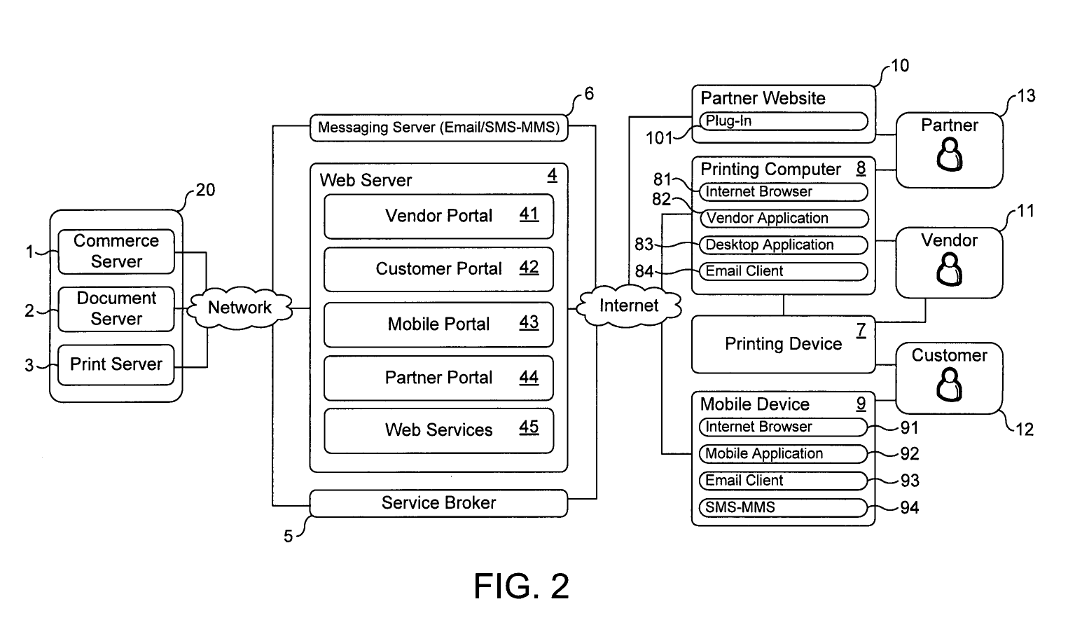

FIG. 2 shows a more detailed schematic diagram of the print system of FIG. 1. The central server 20 comprises a commerce server 1, a document server 2 and a print server 3. These individual servers may be physically separate servers or may each run on a single machine. Customers who use the external computers 30 may acquire credits to be used to print documents and vendors 11 who possess printing resources 7 may be credited with printing credits when they have printed a customer's document. The printing credits may then be redeemed for money or money's worth. Such a credit and payment system may be handled by the commerce server 1. Document server 2 receives documents uploaded from the external computers 30 and transmits these documents to the printing computer 8, so that they may be printed. Print server 3 controls one or more print queues containing print jobs received from the external computers 30 and transmits them to the printing computer 8 when a request for a print job is received.

Web server 4 contains the following portals for communicating with various parties involved in the print process:

Vendor portal 41 is used to register to supply a printing service and to manage the service. It provides the software necessary to add a print system to the print server and begin receiving print jobs;

Customer portal number 42 communicates with server computers 30 (customers are consumers of print services).

Mobile portal 43 is similar to the customer portal 42 but is optimised to communicate with mobile devices;

Partner portal 44 communicates with partners 13. A partner 13 is the owner of a website who wishes to include the print server functionality via web pages on that website. In other words, visitors to the partner's web site may have access to the print system for printing certain documents, in particular, documents supplied by the partner.

The web services 45 component provides the communication channels with the Internet or other network.

Service broker 5 handles communication between the various other components. Messaging server 6 allows for documents to be received from customers in various formats including email, SMS and MMS.

In a typical mobile device 9 components may include an Internet browser 91, a mobile application 92, an email client 93 and an SMS and MMS component 94.

Printing computer 8 may contain an Internet browser 81 used to set up and configure options relating to the print system and communicate with the web server 4. Printing computer 8 may also contain a vendor application 82, which may be run as a background task to control the request and receipt of print jobs from the central server 20. The printing computer 8 may also contain a desk top application 83 used to perform other configuration and printing jobs and may also contain an email client 84.

The operation of the print system shall now be described with reference to the following flow charts detailing an embodiment of the present invention.

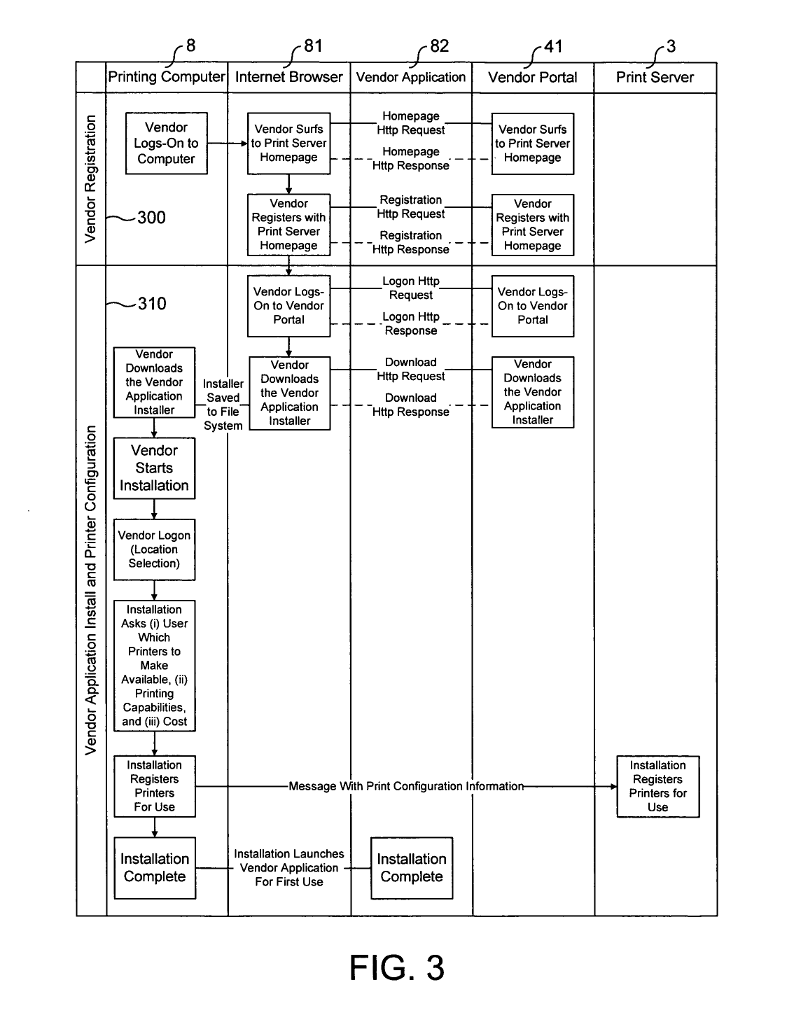

FIG. 3 shows a flow chart describing a method according to an embodiment of the present invention for a vendor to register and install the necessary software to facilitate printing using the print server 3 and system. Action vendor registration 300 is performed first, followed by action vendor application install and printer configuration 310. During vendor registration a new printing resource supplier (vendor 11) registers with the central server 20 in order to offer printing resources. This action takes place over the Internet using a registration website (print server homepage). The vendor 11 logs on to their computer, which may become a printing computer 8. The vendor 11 finds and selects the print server homepage, which receives responses and prompts from the vendor portal 41 via http or similar communication. The vendor 11 then registers with the print server homepage and may for example, create a vendor account.

Once registered the vendor 11 may install and configure printers 7. If not already done so, the vendor 11 logs onto the vendor portal 41 via the account created during action vendor registration 300. The vendor 11 downloads the vendor application installer from the vendor portal 41 and saves the downloaded file locally on the printing computer 8. The vendor 11 then starts the application installer, which prompts the user to indicate which of the local printers may be made available to the print server 3, what the printing capabilities of these printers are, and may also include the cost to be levied for providing these printing services. The installation software may search for any available printers and the vendor 11 may choose which of these found printers to configure. Installation software registers printers for use and communicates the details set up in the configuration steps by sending one or more messages to the print server 3 on the central server 20.

Once installation and configuration is complete the vendor applicator 82 may be started on the printing computer 8 and may run as a background task until its use is required or to report the status of each printing device 7.

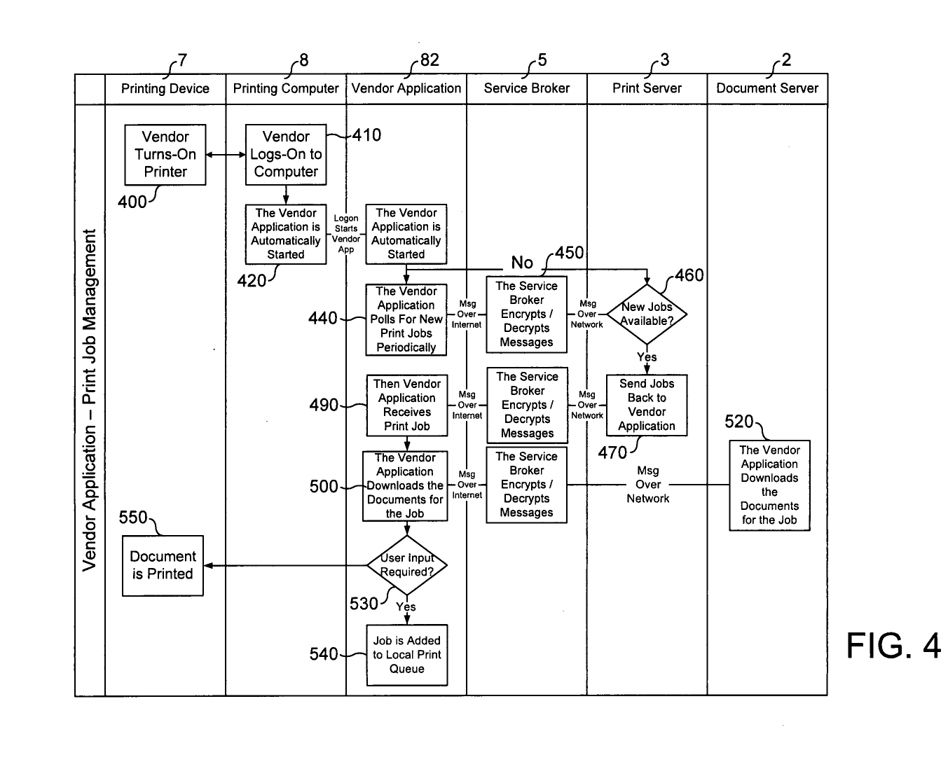

FIG. 4 shows a flow chart illustrating the method of print management from a print job added to a print queue resulting in a printing device 7 printing a document, according to an example embodiment of the present invention. The printer 7 is first turned on, step 400. Next, the printing computer 8 is started and the vendor 11 logs onto the computer 410. On start-up the vendor application 82 may be automatically started 420. Once started the vendor application 80 polls for new print jobs periodically 440. Polling may be achieved by transmitting an encrypted message over the Internet to a service broker 5 which also handles the encryption/decryption of messages 450. In this case the message has the function of enquiring if new jobs are available 460 on a print queue associated with the print server 3. The message may also indicate the availability of one or more printing devices 7. If no print jobs are present or found a message may be sent back via the service broker 5 indicating no print jobs are present and the polling function loops at multiple times and at regular intervals until a new job is found on the print queue associated with the print server 3.

When a new job is found on print server 3 the print job may be sent back to the vendor application 470 by means of a message handled by service broker 5. Vendor application 82 then receives the print job 490. The received print job contains details regarding the printing function required and may specify the file or document associated with the print job. Then, the vendor application 82 may download the document or file associated with the print job 500. This downloading may also achieved by encrypted messaging over a network via the service broker 5 or other suitable transmission technique. Document server 2 containing the associated document then uploads the document to the vendor application 82 in step 520.

Printing of the document or file may then be performed straight away 550 without any further or additional user intervention. If, however, the print job has a state or property indicating that user input is required during printing 530 the print job may be added to a local print queue step 540 or otherwise held by the vendor application 82 but not printed at this time. The print job may only complete with the customer's interaction or consent.

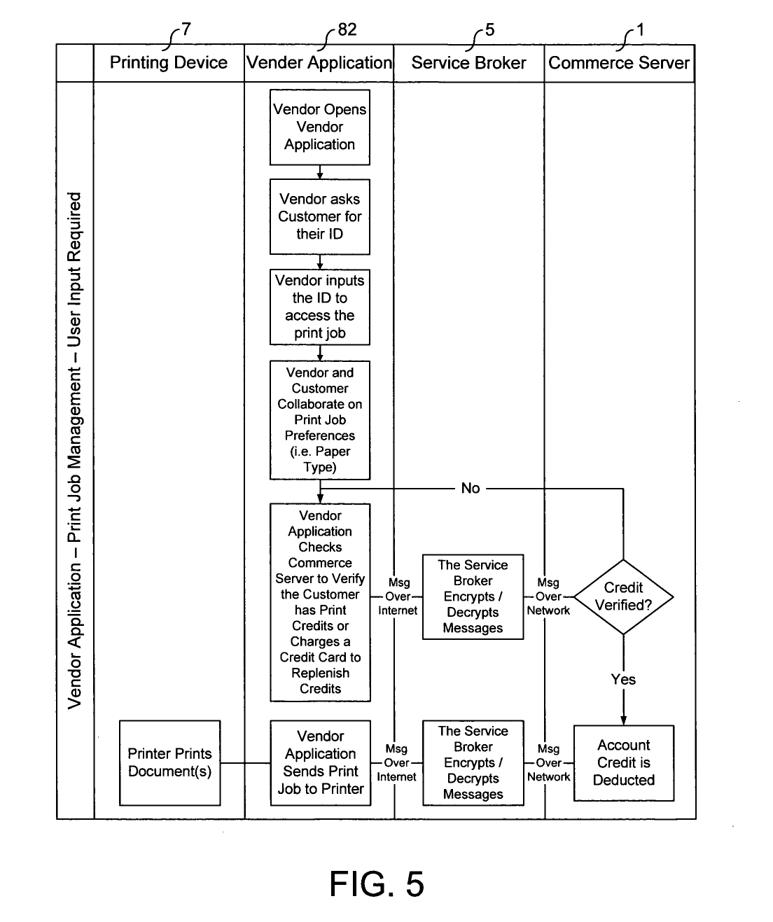

FIG. 5 shows a flow chart of an example method of printing a document when customer 12 or user input is required. This method may be used when a customer 12 collaborates in the actual printing of the document. First the vendor 11 opens the vendor application 82, the vendor obtains the customer's user ID identifying the customer and inputs this ID to access the customer's print job. The vendor application may present the vendor 11 and customer 12 with options to apply to the print job. For instance, the paper type, size or colour may require confirmation or amending. Also the customer 12 may have required that the print job only be printed in their presence in case the document contained confidential or private information.

Once the customer ID and preferences have been confirmed the vendor application 82 checks that the customer 12 has enough print credits to perform the print job or allows the customer to add or replenish print credits by sending a message via the service brokers 5 to the commerce server 1. The commerce server 1 may then verify the credit and prompts the customer 12 via messages again through the service broker 5, to update or replenish credits if not enough credit is available to perform a print job. If sufficient credit is available, the customer's account may be deducted by the required amount of credit and a message may then be sent via the service broker 5 to the vendor application 82 triggering the printing of the document on a printing device 7.

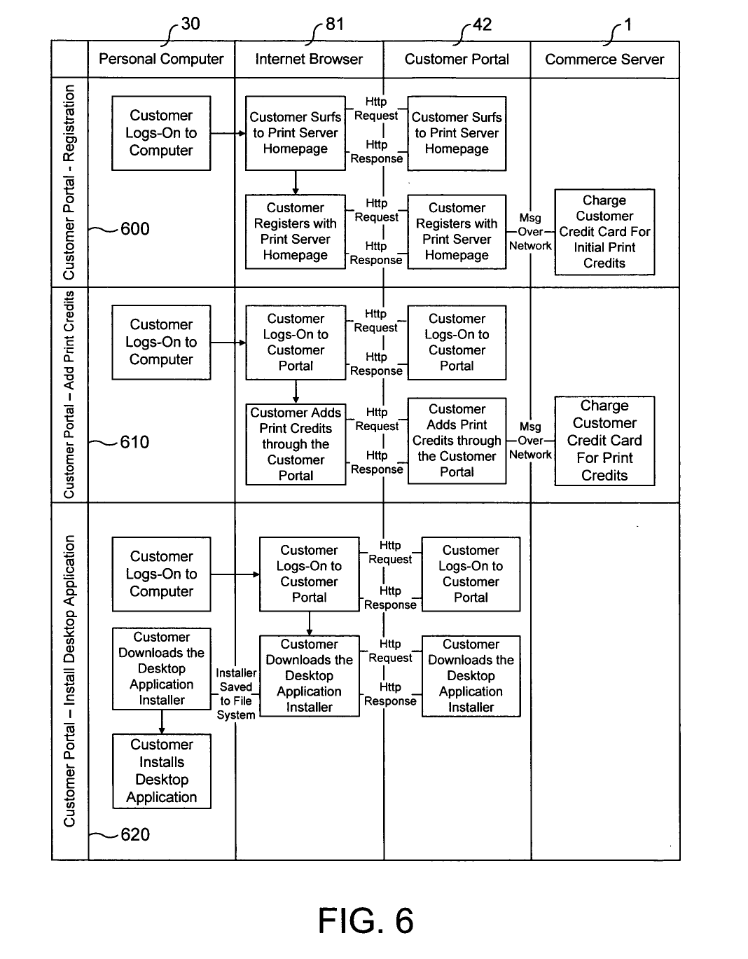

FIG. 6 shows a flow diagram indicating the steps necessary for a customer 12 to register with the print server 3 and system, add print credits to their newly created account and install software to allow them to print documents using the print system.

Action customer registration 600 starts with the customer 12 starting and logging on to their own personal computer 30 and starting an Internet browser 81 so that the customer may surf or navigate to the print server homepage, which may contain a link to the customer portal 42. A customer 12 registers with the print server homepage in order to set up a customer account. An initial credit to the customer's account may be added by using a credit card transaction, which may be handled by the commerce server 1. This results in a certain number of initial print credits being credited to the customer's account and the credit card details may be retained for future use.

Action add print credit 610 may be used to add additional print credits to the customer's account. Again, the customer 12 logs onto their personal computer 30 and uses an Internet browser 81 to log onto the print server homepage via the customer portal 42. Print credits may be added again using secure messages over the Internet to instruct the commerce server 1 to credit the customer's account with additional print credits.

In this particular embodiment a desktop application may be required on the customer's own computer. Action install desktop application 620 installs this desktop application so that the customer 12 can print using the print system. The customer 12 logs onto their personal computer 30 and again logs onto the customer portal 42 using Internet browser 81. Customer 12 downloads a desktop application installer from the customer portal 42 across the Internet and saves the file locally on their system. The installer may be run and the desktop application is installed on the customer's computer 30.

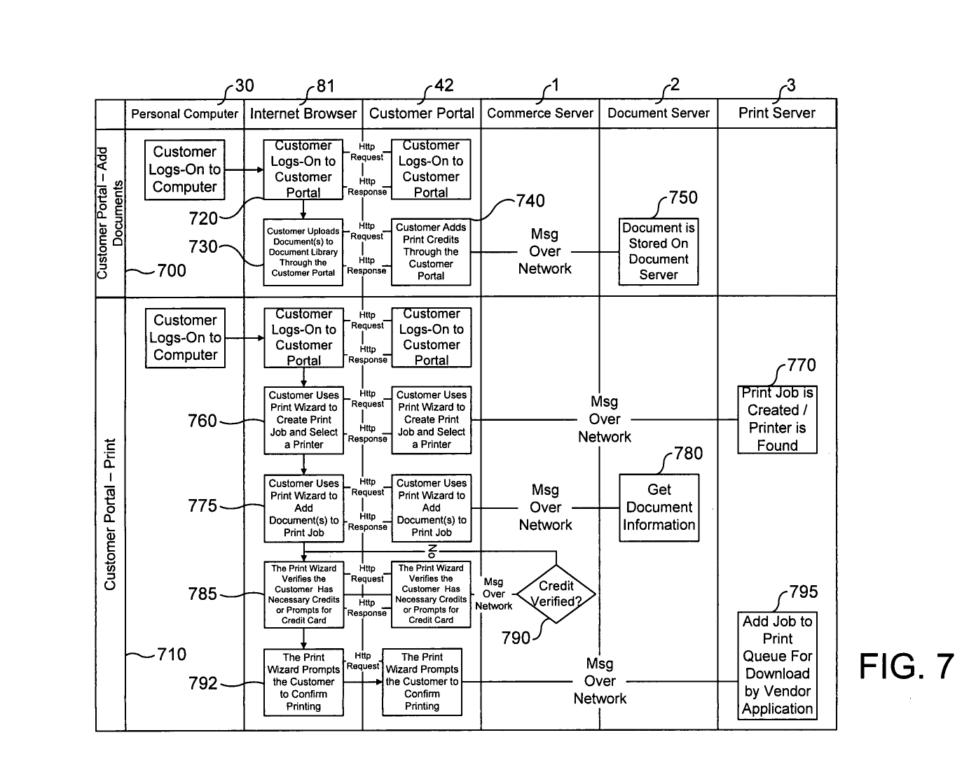

FIG. 7 shows a flow diagram illustrating steps performed by a customer 12 in printing a document. Action add documents 700 is performed by the customer 12 to add a document file to the document server 2. Customer 12 logs onto their personal computer 30, starts an Internet browser 81 and logs on to the customer portal 42 via a web page. Customer 12 logs on to customer portal 42 using their previously created account information, step 720. Using the Internet browser 81 the customer 12 uploads a document or documents to the document server 730 through the customer portal 42. The document or file may be transmitted to the document server 2 through the commerce server 1 and the document may be stored on the document server 2, step 750. The file may be stored together with details of the originating customer. The customer 12 may also add print credits, if necessary, through the customer portal 42 in step 740.

Action print 710 may be initiated by the customer 12 once one or more documents have been uploaded, as described above. Once the customer 12 has logged onto their personal computer 30 they may log onto the customer portal 42 using the Internet browser 81. A print wizard may be used to generate a print job. The print wizard may be operated from the Internet browser 81 and creates the print job and provides the customer 12 with information such as which of the printing devices 7 are available at that time. This information may be sent to the central server 20 from the vendor applications 82 for each print system 60. The print wizard may also indicate properties relating to each of the printing devices 7 such as the cost of printing and what type of printing they may be used for. Collection of this information is described with reference to action 310 on FIG. 3. In using the print wizard and creating a print job and selecting a printer, step 760, the Internet browser 81 may communicate with the customer portal 42, which sends a message to the print server 3 to create a print job. The customer 12 must then add a document or file to the print job in step 775. The customer portal 42 may then receive document information from the document server 2 in step 780 again using messages sent over a network.

Still within the print wizard, customer 12 may verify that print credits should be used to pay for the print job or if insufficient credits are available the print wizard facilitates the replenishment of print credits using a credit card or through saved credit card information 785. Once credit is verified (step 790) from the commerce server 1, the print wizard may prompt the customer 12 to confirm printing in step 792 and a further message may then be sent across the network to the print server to add the print job to the queue. This print job may then be picked up and transmitted to the vendor application 82 in step 795, as described with reference to FIG. 4 above.

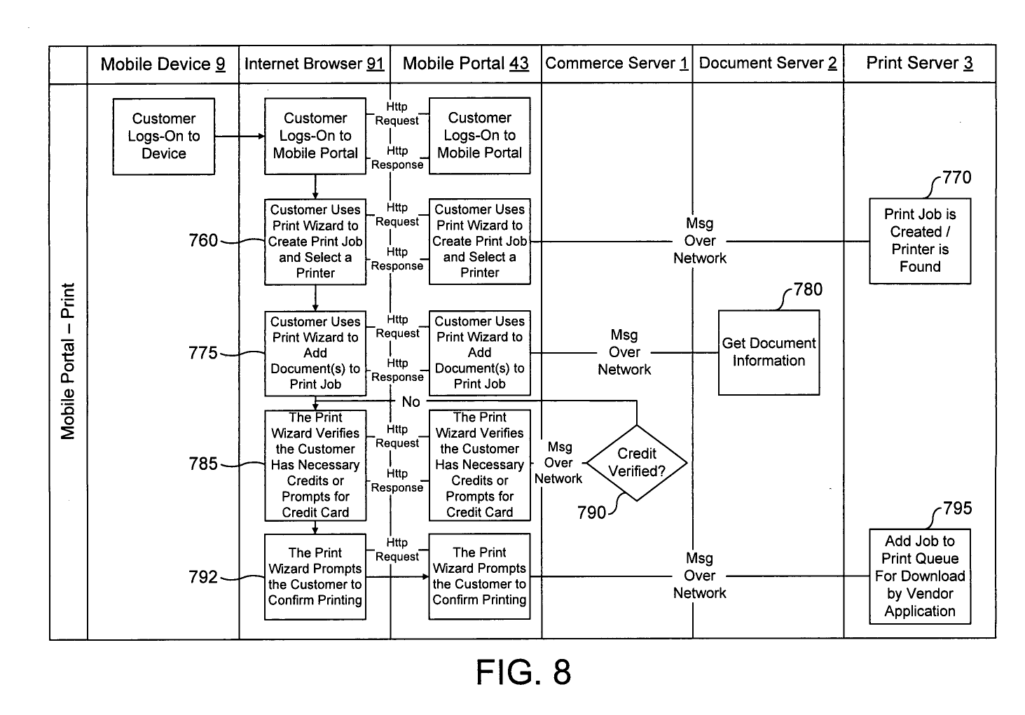

FIG. 8 shows the steps performed by a customer 12 using a mobile device 9 to print a document according to an alternative embodiment of the present invention. This method is similar to the action 710 described with reference to FIG. 7 and similar steps have the same reference numerals.

However, instead of the customer 12 logging onto a personal computer 30 they instead log onto a mobile device 9. The mobile portal 43 carries out similar functions to the customer portal 42.

In this way print jobs may be created from a mobile device such as a mobile phone or PDA, for instance.

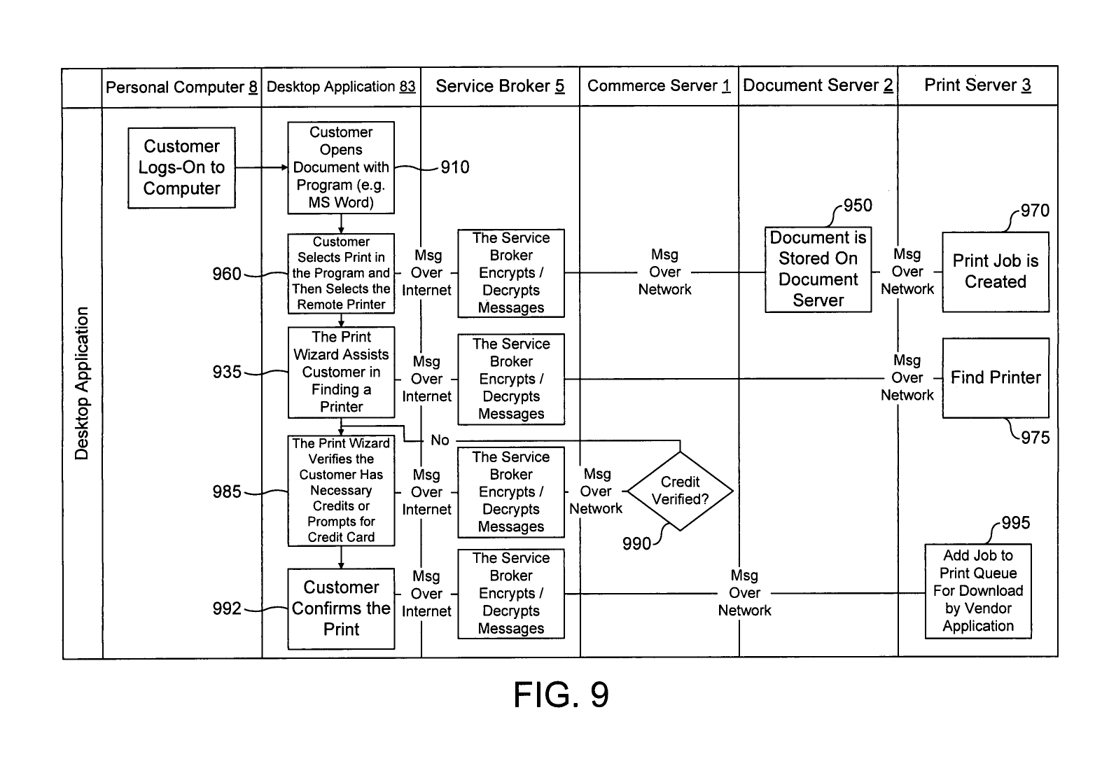

FIG. 9 shows a schematic diagram showing how documents may be printed by the customer 12 directly from a third party desktop application running on a customer's personal computer 30. In other words, a customer 12 may generate a document to be printed and then print it from within the originating document program such as a word processor, for instance. In this way documents may be printed on the printing devices 7 as if the customer 12 had them installed on a local network and chosen the printer from within the print functionality of the installed third party application.

The service broker 5 handles all messages transmitted between components across the Internet or other network. The service broker 5 encrypts or decrypts messages as necessary and may also handle the transmission of files or documents in encrypted or plain form.

The method of printing directly from a third party document originating application, according to one embodiment of the present invention, starts with the customer 12 logging onto their personal computer 30. The desktop application 83 described with reference to FIG. 6, interacts with a third party application that may be used to generate documents for printing, such' as a word processor, spreadsheet or photo-editing software, for instance. The customer 12 opens the document with the third party program, step 910. Then, the customer 12 selects print in the third party application and then selects a remote printer option as the printer to print from (i.e. not a local printer), step 960. The document is then sent via the service broker 5 over the Internet to document server 2 where the document is stored, step 950 and at the same time a print job may be created 970 on the print server 3. A print wizard similar to that described with reference to FIG. 8, assists the customer in finding a printer from those available 935. This is achieved by sending messages via the service broker 5 to the print server 3, which finds a printer 7 using the information collated by the print server 3. As described with reference to FIG. 4 above, the vendor application 82 polls for new print jobs periodically and these polling messages may be used by the print server 3 to determine which printers are available.

Once a printer has been found the print wizard verifies that the customer 12 has necessary credits or if not prompts for a credit card top-up 985. Credit may be verified 990 by querying the commerce server 1 using messages sent via the service broker 5. Once sufficient credit for the particular print job is verified the customer 12 may confirm the print 992. A message may then sent to the print sever 3 across the service broker 5, which adds the print job to the print queue for download by the vendor application 995.

The print job will be placed on the print queue until the next time the vendor application on the selected printer polls for a new print job 440. As a print job will be available 460 the print job will be sent to the querying vendor application 470, as described with regards to FIG. 4 above.

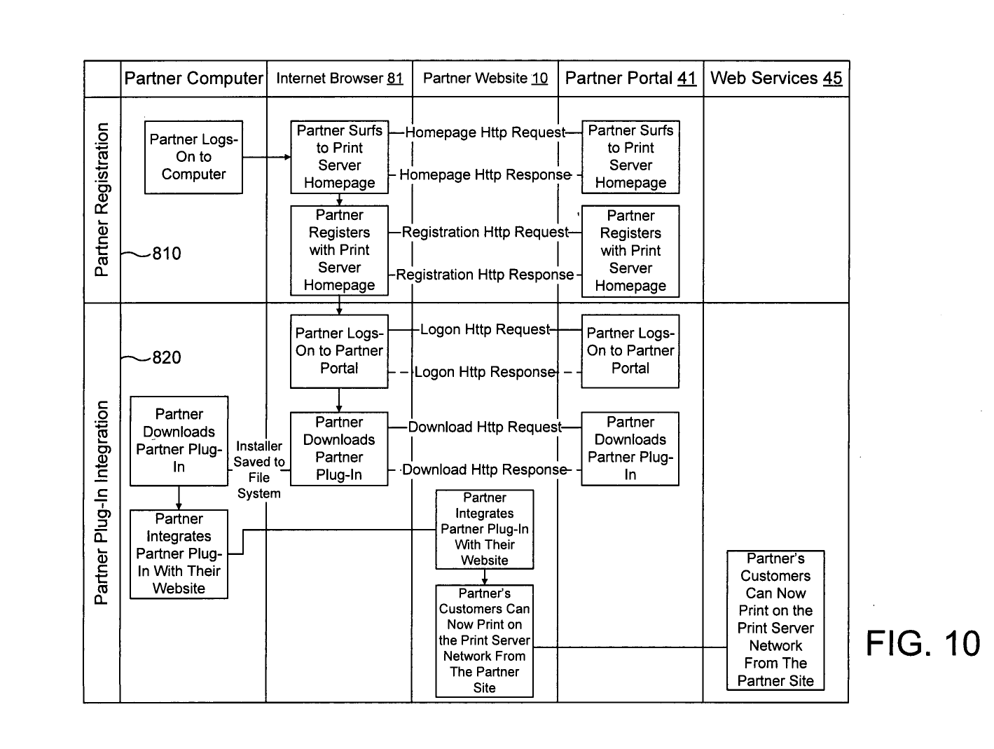

FIG. 10 shows the flow chart for a partner 13 to register and configure their website with a partner plug-in 101, according to a further embodiment of the present invention. Action partner registration 810 allows the partner to register with the print server homepage and action partner plug-in integration 820 allows the partner 13 to configure their own website to use the print server 3 and system. The partner 13 logs on to a partner computer and navigates to the print server homepage using an Internet browser 81. This connects to the partner portal 41 using http messaging or a similar communication protocol. The partner 13 registers with the print server homepage and this registration process includes providing details of the partner 13 and sets up a partner account using the partner portal 41.

Once the partner is registered they may log onto the partner portal 41. The partner 13 then downloads the partner plug-in 101 from the partner portal 41. This plug-in arrives as a file which is saved on the partner's computer.

The partner plug-in 101 may then be integrated into the partner's website such that its functionality is available to visitors on the partners website. The partner plug-in 101 provides visitors with the facility to print directly from the partner's website in a method similar to those described above with regards to the customer printing in FIG. 7.

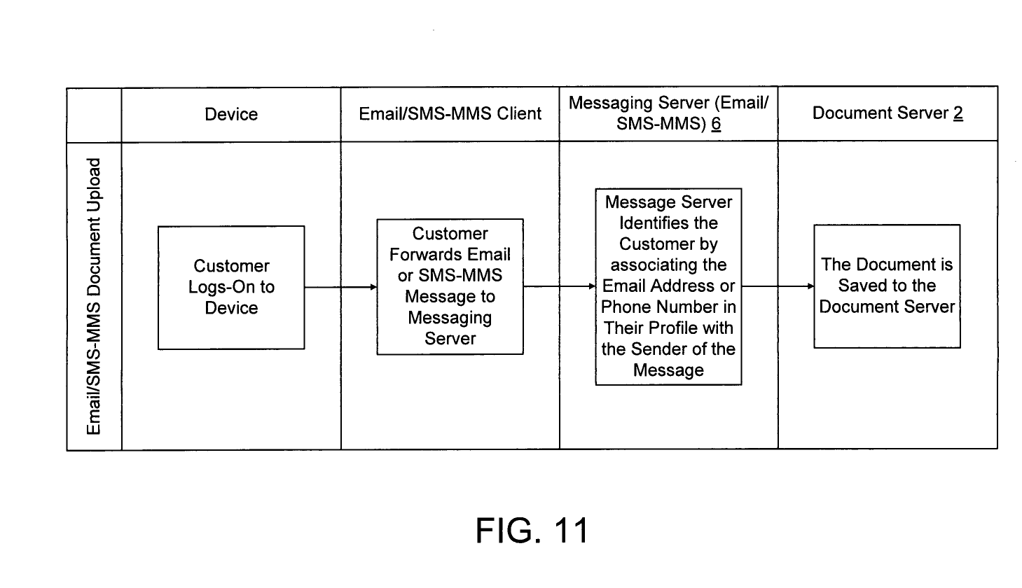

FIG. 11 is a schematic diagram illustrating how customers 12 transmits documents to the document server 2 using email, SMS or MMS messaging. This method is an example of the uploading process, which may be achieved from any suitable type of customer computer 30 including a laptop computer and desktop type computer.

The customer 12 logs onto their particular device and transmits an email or SMS or MMS message to the messaging server 6. The messaging server 6 identifies a customer 12 by matching the originating email address or phone number (if a mobile phone is being used) with a profile in a database containing customer information gathered at the registration stage, described above (action 600 in FIG. 6). Once the message containing document has been identified and associated with a particular customer 12 the document may be saved on the document server 2 and associated with one or more print jobs.

As will be appreciated by the skilled person, details of the above embodiment may be varied without departing from the scope of the present invention, as defined by the appended claims.

For example, FIG. 1 shows the central server connected to the Internet in order to communicate with external computers 30 and the print systems 60 although any suitable network such as an intranet, may be used instead or in addition.

Documents to be printed may include text, images, photographs, books, magazines and legal documents, for instance.

Polling to check for new print jobs on print server 3 may be at irregular times or at regular intervals. Furthermore, the polling function may be achieved from within a printer without requiring an external computer.

The printing computer 8 and printing device 7 comprise the print system 60. However, the functionality of the printing computer 8 including the vendor application 82, may be incorporated within a printing device 7. A print system 60 may therefore comprise a combination of a printing computer 8 and printing device 7 or a single printing device 7 such as a printer. Furthermore, the print system 60 may comprise a printing network of several printing devices 7 and each may have their own local print queues.

Print jobs may be transmitted to the printing computer 8 in response to the receipt of a message from the print system or be pulled by the print system from the print queue associated with the print server 3. Print jobs may be selectively directed to the print system depending on the properties associated with the print job. For instance, the print job may specify that they are only to be printed by a particular printer or one of a set of particular printers or printer type.

The print queue may be populated with more than one print jobs at any one time. The print jobs may be retrieved from the print queue in different ways. For instance, the oldest print jobs may be retrieved first. Alternatively, the most important and/or highest value print jobs may be retrieved first. In another embodiment the print jobs originating from a device closer or further away from the print system may be retrieved first.

The customer 12 may be presented with an option to enter their location (by for instance post code or GPS signal) and the print server and/or customer portal may provide the customer with a selection of print systems nearby or ordered by distance between customer and print facility.

The system may operate in enterprise mode meaning that the entire system is confined to a single enclosed system. For instance, an organisation with several offices may use the print server and system to control their printing facilities by making them available to their own staff, thereby limiting access but improving efficiency. Such a system may be run within an intranet or securely controlled portal or set of portals on the Internet.

1. A print server arranged to:
receive a print job;
add the print job to a print queue;
receive at multiple times from a print system remote from the print queue, a communication checking for the presence of a print job on the print queue; and
transmit to the print system the print job in response to the communication.

2. The print system of claim 1, wherein the print system and the print server are in communication via a network.

3. The print server of claim 1, wherein the print server further comprises a file store arranged to transmit files associated with the print job to the print system.

4. The print server of claim 1, wherein the communication is transmitted as a message across a message broker.

5. The print server of claim 1, wherein the communication indicates the availability of the print system.

6. The print server of claim 1, wherein the print server is further arranged to receive an instruction to hold the print job prior to printing.

7. The print server according to claim 6, wherein the print server is further arranged to transmit an instruction to print the held print job.

8. The print server of claim 7, wherein the print command is validated by a print requester.

9. The print server of claim 1 further comprising a file store arranged to store files associated with print jobs.

10. The print server of claim 9, wherein the file store is arranged to receive files associated with print jobs from a file transmission type selected from the group consisting of: email, FTP, HTTP, SMS, MMS, WAP, GPRS and encrypted file transfer.

11. The print server of claim 1, wherein the print server is further arranged to receive the print job from a user computer.

12. The print server according to claim 11, wherein the print server is further arranged to receive a file from the user computer.

13. The print server of claim 12, wherein the print server is further arranged to associate the file with the print job.

14. The print server of claim 13, wherein the print server is further arranged to associate printing preferences with the print job.

15. The print server according to claim 11, wherein the user computer is selected from the group consisting of: a personal computer, a laptop computer, a mobile computer, a cell phone and a PDA.

16. The print server of claim 1, wherein the print server is further arranged to receive printing options associated with the print jobs.

17. The print server according to claim 16, wherein the printing options are selected from the group consisting of: paper type, ink, toner, colour, size, duplex and collate.

18. The print server of claim 1, wherein the print server is further arranged to receive the status of the print system.

19. The print server of claim 18, wherein the print server is further arranged to receive the status of any printers associated with the print system.

20. The print server of claim 18, wherein the print server is further arranged to set the status of the print system and/or any associated printers as being offline if it does not receive a valid status from the print system.

21. The print server of claim 18, wherein the print server is further arranged to communicate the printer status to a user.

22. The print server of claim 1, wherein the print server is further arranged to receive communications from a plurality of print systems each having a separate location and one or more associated printers.

23. The print server according to claim 22, wherein the print server is further arranged to associate a print job with one of the plurality of print systems having a particular location.

24. The print server according to claim 23, wherein the particular location is user specified.

25. The print server of claim 2, wherein the network is the Internet or an intranet.

26. The print server of claim 1, wherein the print queue is associated with the print server.

27. The print server of claim 1, wherein the print queue is within the print server.

28. A method of printing comprising the steps of:
adding a print job to a print queue;
receiving a communication from a print system remote from the print queue checking for the presence of a print job;
transmitting the print job from the print queue to the print system in response to the communication; and
printing the transmitted print job using the print system.

29. The method of claim 28 further comprising the steps of:
transmitting a file to a file store; and
associating the transmitted file with the print job.

30. The method of claim 28 further comprising the step of retrieving a file associated the print job from a file store.

31. The method of any of claim 28 further comprising monitoring the status of a printer.

32. The method of claim 31 further comprising the step of transmitting the status of the printer.

33. The method of claim 31, wherein the printing step is performed on an available printer as determined from the status.

34. The method according to claim 28 further comprising the step of adding the print job to a local print queue associated with a printer.

35. The method according to claim 28 further comprising the step of maintaining a list of available printers.

36. The method according to claim 28 further comprising the step of presenting to a user a list of available printers.

37. The method of claim 36, wherein the list of available printers includes one or more properties for each available printer, wherein the properties are selected from the group consisting of: location, quality, print type and cost.

38. A method of printing comprising the steps of:
uploading a file to a file store;
selecting a remote printer from a list of available printers; and
creating a print job for printing the uploaded file with the selected printer.

39. The method of claim 38, wherein the file store is indexed.

40. The method of claim 39, wherein the indexed file store is searchable.

41. The method of claim 39, wherein the file store is indexed by a username of whoever uploaded the file.

42. The method according to claim 38, wherein the list of available printers is sorted.

43. The method of claim 42, wherein the list of available printers is sorted by one or more parameters selected from the group consisting of: print cost, environmental cost of print and location.

44-46. (canceled)

47. A computer programmed to:
transmit a communication indicating the availability of a print system at multiple times to a print server having a print queue, wherein the print server is remote from the computer;
receive from the print queue a print job in response to the communication; and
print the received print job using the print system.

48. The computer of claim 47 further programmed to receive a communication indicating that the print job is available prior to receiving the print job from the print queue.

49. The computer of claim 48 further programmed to request the print job after receiving the communication that the print job is available.

50. A method of printing comprising the steps of:
transmitting a communication indicating the availability of a print system at multiple times to a print server having a print queue, wherein the print server is remote from the computer
receiving from the print queue a print job in response to the communication; and
printing the received print job using the print system.

51. The method of claim 50 further comprising the step of receiving a communication indicating that the print job is available prior to receiving the print job from the print queue.

52. The method of claim 51 further comprising the step of requesting the print job after receiving the communication that the print job is available.

53-57. (canceled)
